(19) United States
(12) Patent Application Publication
(10) Pub. No.: US 2010/0090862 A1
(43) Pub. Date: Apr. 15, 2010

(54) POINT-OF-USE ENERGY MONITORING AND MANAGEMENT

(76) Inventors: Nicole M. Dubrow, Schwenksville, PA (US); Michael Block, Anaheim, CA (US)

Correspondence Address: BROSEMER, KOLEFAS & ASSOCIATES, LLC, 1 BETHANY ROAD, BUILDING 4 - SUITE # 58, HAZLET, NJ, 07730, US

(21) Appl. No.: 12/554,090

(22) Filed: Sep. 4, 2009

Related U.S. Application Data
(60) Provisional application No. 61/094,398, filed on Sep. 4, 2008.

(51) Int. Cl. G08C 19/16

(52) U.S. Cl. 340/870.01

(57) ABSTRACT

A system for monitoring and managing the energy consumption of designated devices or services obtains the point-of-use energy consumption of the designated devices or services and collects this consumption information in various formats as data. The collected data may be analyzed for peak load analysis and load shedding recommendations, among other analysis. The data may be displayed on a user interface to an energy consumer in various formats that permit the consumer to make decisions and take actions based on the displayed data or the analysis. The data may be displayed in real-time format so that the consumer may observe the instant energy consumption of a particular device. The consumer may also view a device's energy consumption to-date over a predetermined period of time. The consumer may also take an action through the system to reduce the consumer's overall energy consumption.

### RELATED PATENT APPLICATIONS

This application claims the benefit under 35 U.S.C. §119 of U.S. Provisional Application No. 61/094,398, filed Sep. 4, 2008, the entire contents of which are hereby incorporated by reference for all purposes into this application.

### FIELD OF INVENTION

The present invention generally relates to systems and methods for monitoring and managing the consumption of resources, such as energy.

### BACKGROUND

Due to the cost of energy, energy consumers are motivated to learn as much as possible regarding their consumption of energy as well as the terms and conditions under which energy suppliers supply energy to consumers. Further, due to the many disparate locations and types of devices and services that consume energy as well as the dynamic nature of the price of energy, there is a need for real-time information regarding the consumer's energy consumption.

Energy consumers may or may not understand that, due to the energy providers' tariff conditions as well as energy market conditions, energy is more expensive at certain times of the day and during certain seasons. For example, many utilities price energy delivery more expensively during a “peak” time as compared to a “non-peak time.” Many energy consumers do not know exactly at what time of day they may be paying higher rates for energy. Also, energy consumers may not know which devices or services may be consuming the most energy. Further, many energy consumers are not aware that many devices and services consume energy even when those devices or services appear to the consumer to be in an inactive state. These inactive loads, also known as “vampire” loads, may contribute substantially over time to a consumer's energy consumption. Energy consumers would appreciate knowing what amounts of energy are being consumed by specific devices or services, both in real-time form and in an accumulated consumption (i.e., to-date and/or to current time) form, and at what time the energy is consumed, i.e., peak or non-peak. Energy consumers would also appreciate knowing their total energy consumption in both real-time form and in an accumulated consumption form.

Energy consumers would also appreciate the analysis and indication that may be performed on the various point-of-use energy consumption information and the total energy consumption information, both in real-time form and accumulated form. The kind of analysis and indication that may be performed on this data may be, but is not limited to: peak load analysis; peak load time indication; peak load shedding recommendations; and suggested pre-configured load control. Also, energy consumers would appreciate the ability to take control actions regarding the operational characteristics of various energy consuming devices and services based on the information and the analysis thereof.

Additionally, energy consumers may have a great interest in not only their electrical energy consumption, but also their consumption of other resources such as, but not limited to, natural gas, water, fuel oil, and the like. For example, it would be useful for natural gas consumers to know what their total accumulated gas consumption is for the current month, at what rate gas is being consumed in total in real-time, and at what rate specific gas appliances, such as a stove or furnace, are consuming gas in real-time.

Every type of energy consumer, such as but not limited to residential, commercial, industrial and government/military would find such real-time and total energy consumption information useful. Further, all energy consumers would also find useful the ability to analyze the real-time and accumulated energy consumption information as well as the ability to control various energy consuming devices in light of the analysis.

In addition to energy consumers, energy providers, such as electric utilities, also have a great interest in monitoring the consumption of its customers, not only on a monthly basis for billing purposes, but on much shorter time scales, even on a real- or near real-time basis. Studies indicate that electric grid control centers receive data approximately two seconds after catastrophic events, which is often too late for avoidance of system instability and ultimately cascaded system segment blackouts. (See R. D. Tucker, End-to-End Communications for Smart Grid, Tucker Engineering Assoc. Inc., Apr. 16, 2009.) The more timely collection and provision of load data from consumers can only help to reduce this delay, improving the chances of avoiding system instability.

### SUMMARY

In an exemplary embodiment in accordance with the principles of the invention, a system for monitoring and managing the energy consumption of designated devices or services is a contemplated. The system obtains the point-of-use energy consumption of the designated devices or services and collects this consumption information in various formats as data. The collected data may be analyzed for peak load analysis and load shedding recommendations, among other analysis. The data may be displayed on a user interface to an energy consumer in various formats that permit the consumer to make decisions and take actions based on the displayed data or the analysis. The data may be displayed in real-time format so that the consumer may observe the instant energy consumption of a particular device. The consumer may also view a device's energy consumption to-date over a predetermined period of time. The consumer may also take an action through the system to reduce the consumer's overall energy consumption.

An exemplary embodiment of a system for measuring energy consumption comprises a first microprocessor. The first microprocessor is configured to receive a measurement of an energy consumption of a predetermined energy load and convert the measurement into an electrical signal. The system also comprises a second microprocessor. The second microprocessor is configured to convert the electrical signal into a signal based on a predetermined communication protocol and transmit the converted signal based on the predetermined communication protocol to a third microprocessor.

An exemplary embodiment of a method of managing energy consumption comprises measuring an energy consumption of a predetermined energy load; converting the measured energy consumption into an electrical signal; converting the electrical signal into a signal based on a predetermined communication protocol; and transmitting the converted signal based on the predetermined communication protocol.

In view of the above, and as will be apparent from the detailed description, other embodiments and features are also possible and fall within the scope of the invention.

### BRIEF DESCRIPTION OF THE FIGURES

Some embodiments of apparatus and/or methods in accordance with embodiments of the present invention are now described, by way of example only, and with reference to the accompanying figures in which:

FIG. 1 depicts a block diagram of an energy monitoring and management system in accordance with an exemplary embodiment;

FIG. 2 depicts a block diagram of a hub (or “hub”) node of the energy monitoring and management system in accordance with an exemplary embodiment;

FIG. 3A depicts a block diagram of an exemplary node interface device of the energy monitoring and management system in accordance with an exemplary embodiment, and FIG. 3B depicts a schematic of an exemplary node interface device of the energy monitoring and management system in accordance with an exemplary embodiment;

FIGS. 4A-4E depict block diagrams of various node interface devices of an energy monitoring and management system in accordance with an exemplary embodiment; and

FIGS. 5A and 5B depict exemplary image frames displayed on a user interface in accordance with an exemplary embodiment.

FIG. 6 depicts an exemplary embodiment of a system for use with an electrical power distribution panel.

### DESCRIPTION OF EMBODIMENTS

### System Overview

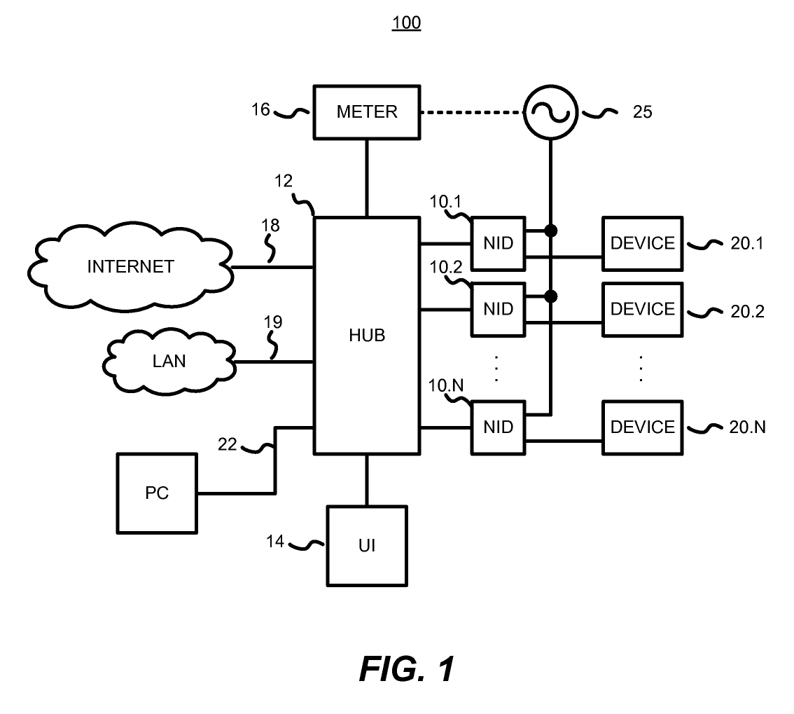

FIG. 1 illustrates a block diagram of an exemplary embodiment of an energy monitoring and management system 100. As shown in FIG. 1, system 100 includes a hub 12 which is in communication with one or more node interface devices (NIDs) 10, each NID 10 being associated with a respective energy consuming device 20. The communication between hub 12 and each NID 10 may be wired or wireless. Hub 12 may be in communication with a user interface (UI) 14. The communication between hub 12 and the UI 14 may be wired or wireless. In an exemplary embodiment, the UI 14 may take the form of a thermostat, for example, that has the ability to communicate with the hub 12. In other embodiments, the UI 14 may be a configurable part of the hub 12.

The hub 12 may be a stand-alone device or it may be part of another system, such as a card in a personal computer or a power distribution panel, for example.

The hub 12 may also be in communication with a third-party device, such as but not limited to, an energy company's meter 16 (e.g., a utility meter), preferably a smart meter. In the embodiment of FIG. 1, meter 16 is associated with the provision of electric energy such as via electrical power mains 25 of premises at which devices 20 are located. The communication between the hub 12 and the utility meter 16 may be wired or wireless. In some embodiments, the hub 12 may be a configurable part of the utility meter 16.

The hub 12 may also be in communication with the Internet (World Wide Web), a local area network (LAN), and/or a personal computer or the like, via wired or wireless connections 18, 19 and 22, respectively.

The various communication interfaces among the elements of FIG. 1 may be in compliance with any suitable open or proprietary communications protocol or standard, including but not limited to: Ethernet, RS232/485, USB, wireless RF (e.g., Bluetooth), infrared, “X10” or similar, HTML, 802.x wireless, Modbus, Device Net I. Control Net, SCADA, Wifi, Universal Power Bus, Zigbee, and z-wave, among others.

In implementations in which the hub 12 interfaces to a smart meter 16, the hub 12 can provide data to the smart meter which the smart meter may send to the utility. Also, it is contemplated that the meter 16 may send data from the utility, such as actual power usage, peak hours, rate data, demand response, statistical data and the like to the hub 12.

In the exemplary embodiment of FIG. 1, each of the one or more NIDs 10 is coupled to an energy consuming device 20. Energy consuming devices 20 may be, but are not limited to, those devices commonly found in residential, commercial or industrial environments, such as air conditioning units, lighting units, refrigerators, furnaces, tools, appliances, and the like. Exemplary embodiments of NIDs are described in greater detail below.

In the exemplary embodiment FIG. 1, each NID 10 is coupled to electrical power mains 25. Electrical power from power mains 25, typically 120 volts AC at 60 Hz or 240 volts AC at 50 Hz, but not limited to these, is provided to each of device 20 via a respective NID 10. The power provided to each device 20 may be monitored and/or controlled by its respective NID 10. As described in greater detail below, each NID 10 can communicate to hub 12 information related to the monitoring of power applied to its respective device 20. Additionally, those NIDs 10 capable of controlling the application of power to a device 20 can do so in accordance with commands from hub 12 and/or independently of hub 12.

Each NID 10 will preferably have a specific identifier that is used in communications with hub 12 in order to distinguish among multiple NIDs. Identifiers can be assigned to the NIDs by any of a variety of suitable means, such as by switches on the NID, automatically by hub 12, by pre-progamming upon manufacture, or user-programming via hub 12, among other possibilities.

### Hub

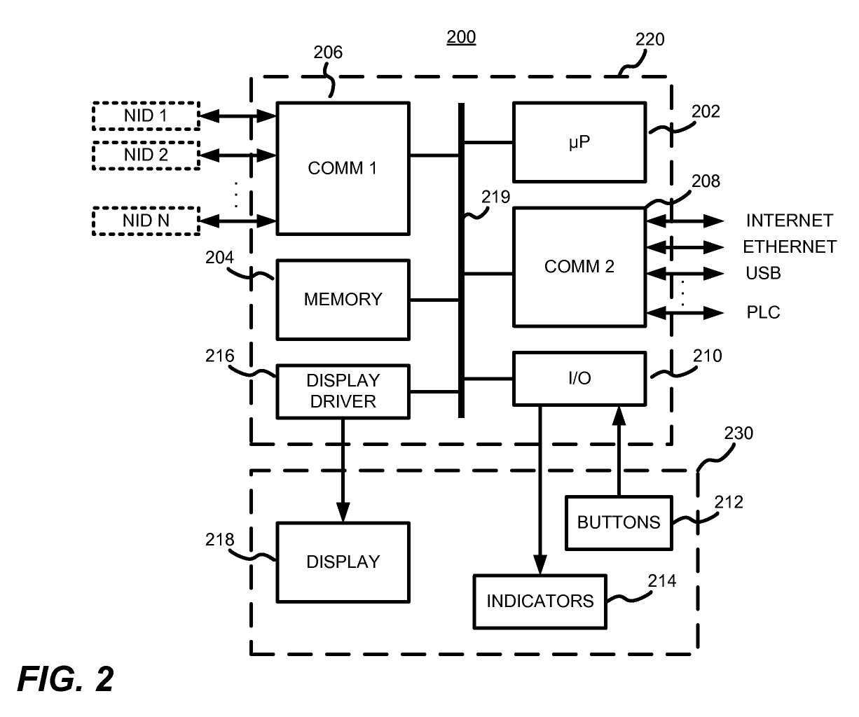

FIG. 2 is a block diagram of an exemplary embodiment of a hub 200. As seen in FIG. 2, hub 200 has at least one programmable microprocessor 202, memory 204 and various communications and interface blocks 206, 208, 210 and 216, interconnected via a bus structure 219. The aforementioned blocks and bus structure can be implemented in an integrated circuit 220, as discrete circuits, or a combination of both.

Communication block (COMM 1) 206 provides hub 200 with an interface capability to communicate with individual NIDs. Communication block (COMM 2) 208 provides hub 200 with an interface capability with one or more third-party devices or software systems via one or more of the aforementioned communications interfaces. Hub 200 may communicate with more than one third-party device at the same time and may do so with different communications protocols.

Hub 200 may also include or be coupled to a user interface 230. User interface 230 may include various combinations of buttons 212 and indicators 214 and one or more displays 218. It is contemplated that buttons 212 may include any suitable user input devices such as switches, keys, or the like, indicators 214 may include LEDs, lamps, or other simple display devices, and that display 218 may include larger display devices such as multi-pixel flat panel LCD displays or the like. In the exemplary arrangement shown, I/O block 210 interfaces with buttons 212 and indicators 214, whereas display driver block 216 interfaces with display 218.

Through user interface 230, a PC attached directly to hub 200, or a PC or mobile device over a network connection to hub 200, among other possibilities, a user may configure hub 200 to perform various functions. For example, hub 200 can be configured to perform automatic load-shedding, system consumption analysis, alarm generation, and individual device analysis, among other possible functions described below in greater detail.

A user can also use the aforementioned interfaces to perform system setup via hub 200. For example, where a system includes multiple NIDs in communication with hub 200, the user can specify a user-friendly name for each NID, such as a description of the device to which the NID is coupled (e.g., “refrigerator” or “furnace” or “big TV”, etc.), which the hub 200 will use when interacting with the user in connection with a device in the system. The user-specified name associated with a NID can be the same as or different than the identifier used in communications between the NID and the hub 200.

The firmware and configuration, memory, and databases of hub 200 and/or of the NIDs may be upgraded, for example, from a PC attached directly to hub 200, or from a server over a network connection to hub 200, among other possibilities.

### Node Interface Device (NID)

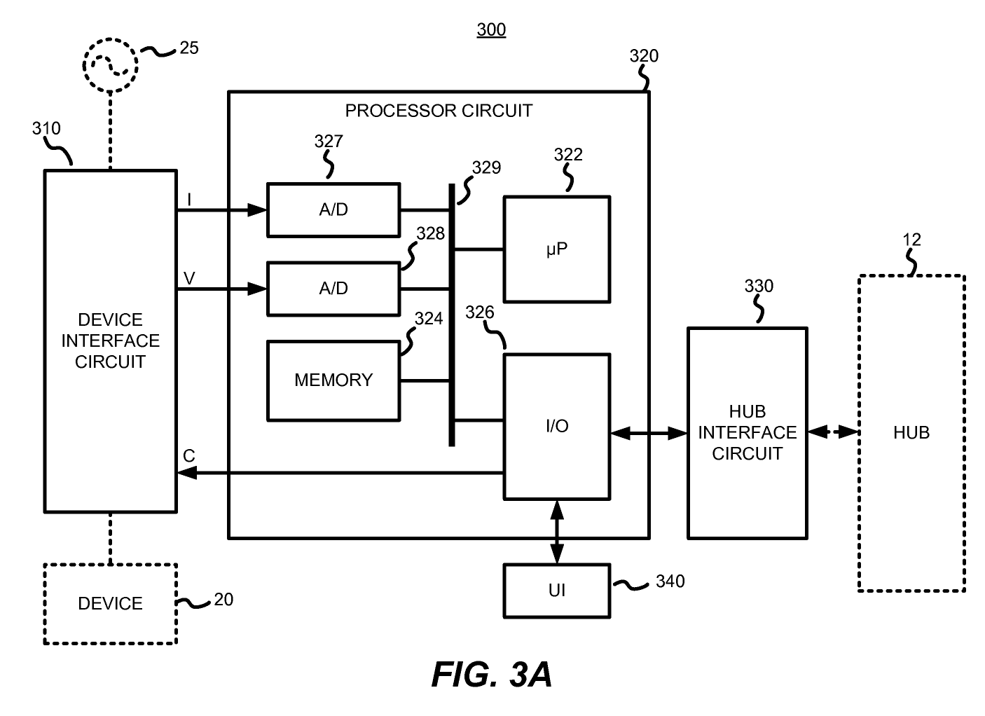

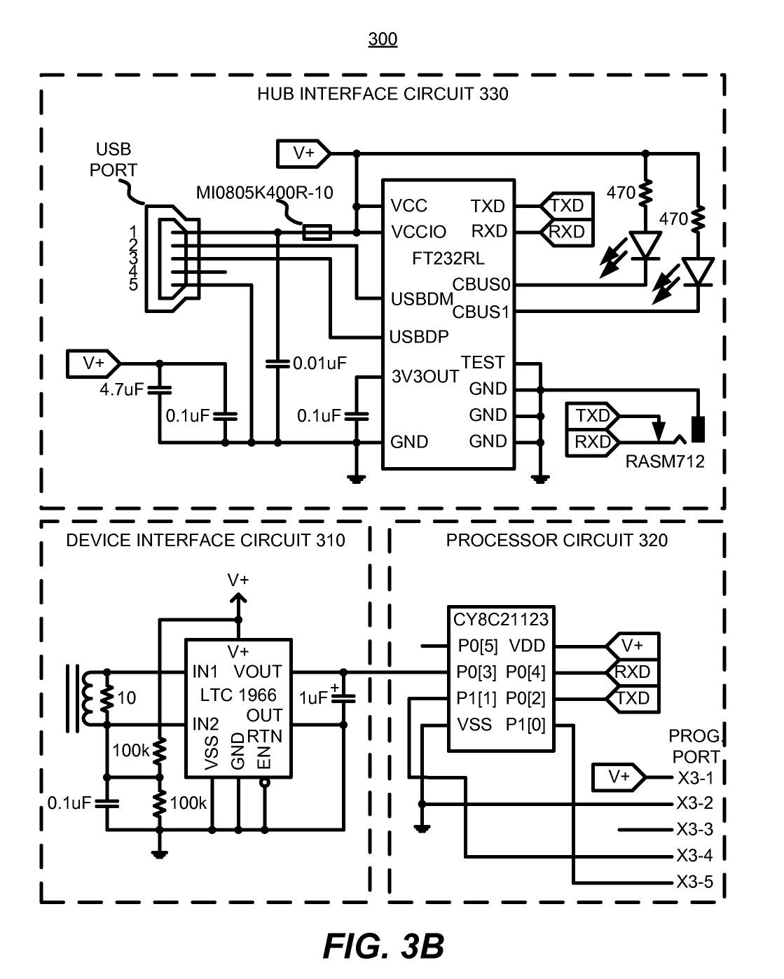

FIG. 3A depicts a block diagram of an exemplary embodiment of a node interface device (NID) 300 in accordance with the principles of the invention. NID 300 generally comprises three circuits: device interface circuit 310, processor circuit 320 and hub interface circuit 330. Generally, device interface circuit 310 monitors and/or controls the application of power from power mains 25 to a device 20; processor circuit 320 processes the measurements from device interface circuit 310; and hub interface circuit 330 provides a communications interface for the NID with hub 12.

In an exemplary embodiment, device interface circuit 310 has an “AC pass-through” arrangement with a standard inlet or corded plug coupled to power mains 25 and a standard outlet coupled to an energy consuming device 20. Circuit 310 preferably has a negligible or no effect on the AC power passing through it.

Device interface circuit 310 monitors, preferably in real time, one or more parameters relating to the energy consumption of a respective device 20, such as the current drawn by and/or the voltage applied to the device 20. Current drawn by device 20 can be monitored by any of a variety of suitable arrangements, including inductively, such as with a transformer or toroid, or resistively, such as by measuring the voltage drop across a known resistance, or a four-wire resistor arrangement, among others. Voltage applied to device 20 can also be monitored by any of a variety of suitable arrangements, such as with a resistor divider to provide a scaled version of the voltage applied. In the exemplary embodiment shown, circuit 310 provides analog signals I and V representative of the current and voltage, respectively, to processor circuit 320. The analog signals I, V are preferably scaled to a voltage range (e.g., 0-5 volts) that can be used by a common analog-to-digital (A/D) converter. Circuit 310 may also provide a reference voltage for use by an A/D converter to properly scale the analog signals. In an exemplary embodiment, the analog signals I and V generated by circuit 310 are subjected to minimal or no filtering so that they will retain the relevant waveshape information of the current and voltage that they represent. Circuit 310 may or may not include a spike suppressor to suppress spikes in the power applied to device 20. In an exemplary embodiment, it may be desirable to detect spikes in the power applied and to analyze and report those.

Device interface circuit 310 may also control the application of power to the device 20 via a control signal C from processor circuit 320. Device interface circuit 310 may include a relay or a dimmer, among other possibilities, which can provide a binary (ON/OFF) or linear application of power to device 20 in accordance with control signal C.

Processor circuit 320 preferably includes programmable processor 322, memory 324, I/O block 326 and A/D converters 327 and 328 for converting analog signals I and V, respectively, from device interface circuit 310 to digital form for provision to microprocessor 322. The aforementioned blocks may be interconnected via a bus 329 and may be implemented as discrete components, in one or more ICs, or a combination thereof.

In an exemplary embodiment, A/D converters 327, 328 have resolutions of 8-bits or more, and sampling rates that preferably allow multiple samples of the I and V signals over each full or half cycle of the power provided to device 20. In an exemplary embodiment, for f Hz AC power (e.g., f=50, 60), for example, signals I and V will have waveforms that generally approximate f Hz sinusoidal signals, assuming no rectification, and the sampling rates of A/D converters 327, 328 will be N*60 Hz, where N≧1, for a sampling rate of 60 Hz or more. In an exemplary embodiment, N≦10⁶, for a sampling rate of 60 MHz or less. Higher sampling rates may be desirable to capture spikes, higher frequency noise, or the like.

In a further exemplary embodiment, A/D converters 327, 328 can be replaced with one A/D converter, where only one signal is to be sampled, or where a switching circuit (e.g. a 2-to-1 analog mux) provided to switch the input of the A/D converter between the signals to be sampled.

The digital measurement values from A/D converters 327, 328 can be stored in memory 324, provided via I/O block 326 to hub interface circuit 330 for communication to hub 12, and/or further processed by processor 322. For example, processor 322 may perform various operations using the measurement values such as calculating power (P=V×I), and/or determining average and/or peak values, among other possibilities. Alternatively, such operations can be carried out at the hub based on raw measurement data from the NID. Processor 322 may also process the raw measurement data and/or calculated data in accordance with the requirements of hub interface circuit 330.

Where applicable, processor 322 can control device interface circuit 310 via I/O block 326 to vary or to turn power to device 20 on or off.

As shown in FIG. 3A, NID 300 may also include a user interface 340 including buttons, indicators and/or a display. User interface 340 can be coupled to I/O block 326 of processor circuit 320. The user interface 340 can be used for a variety of purposes, including configuring NID 300 and/or obtaining measurement or calculated data, among other possibilities.

Hub interface circuit 330 is used to communicate with hub 12. Circuit 330 may include a processor. Circuit 320 converts the signal from circuit 310 according to the requirements of circuit 330.

The communication between the NID 10 and the hub 12 may be wired or wireless and may adhere to any suitable open or proprietary communications protocol or standard, including but not limited to: Ethernet, RS232/485, USB, wireless RF (e.g., Bluetooth), infrared, “X10” or similar, HTML, 802.x wireless, Modbus, Device Net I. Control Net, SCADA, Wifi, Universal Power Bus, Zigbee, and z-wave, among others.

In an exemplary embodiment, processor 322 of processor circuit 320 may also communicate with a processor that may be part of device 20. Such a processor in device 20 may provide processor 322 with various calculated and measured data. Communication between processors can be effected by a variety of suitable arrangements, including, for example, via a dedicated data interface between device 20 and NID 300, or power line communications (PLC) via device interface circuit 310 or independently of circuit 310.

FIG. 3B shows a schematic diagram of an exemplary embodiment of a NID 300. Device interface circuit 310

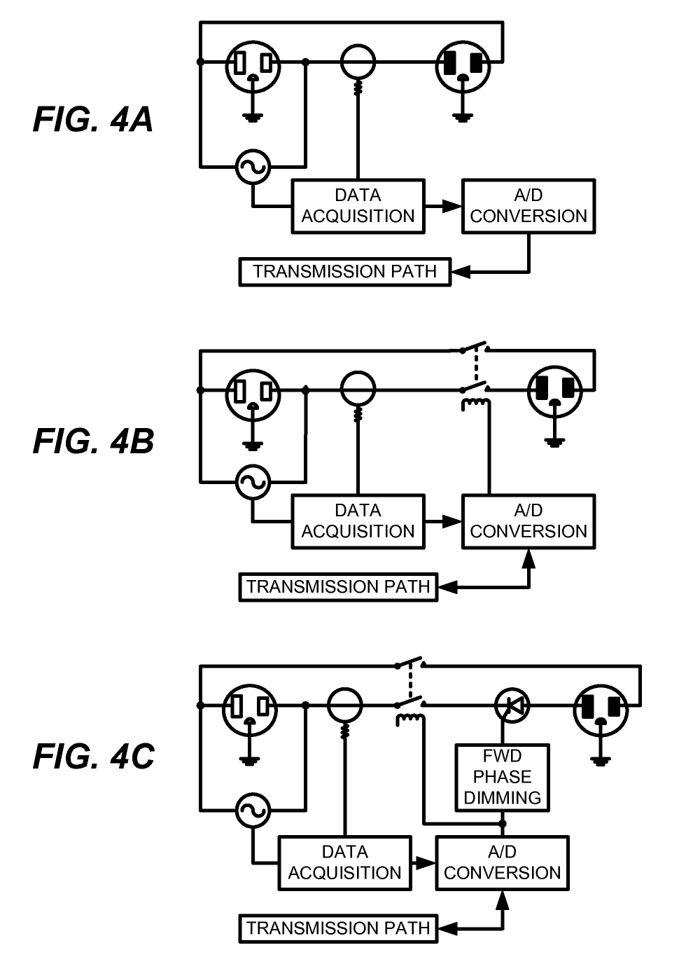

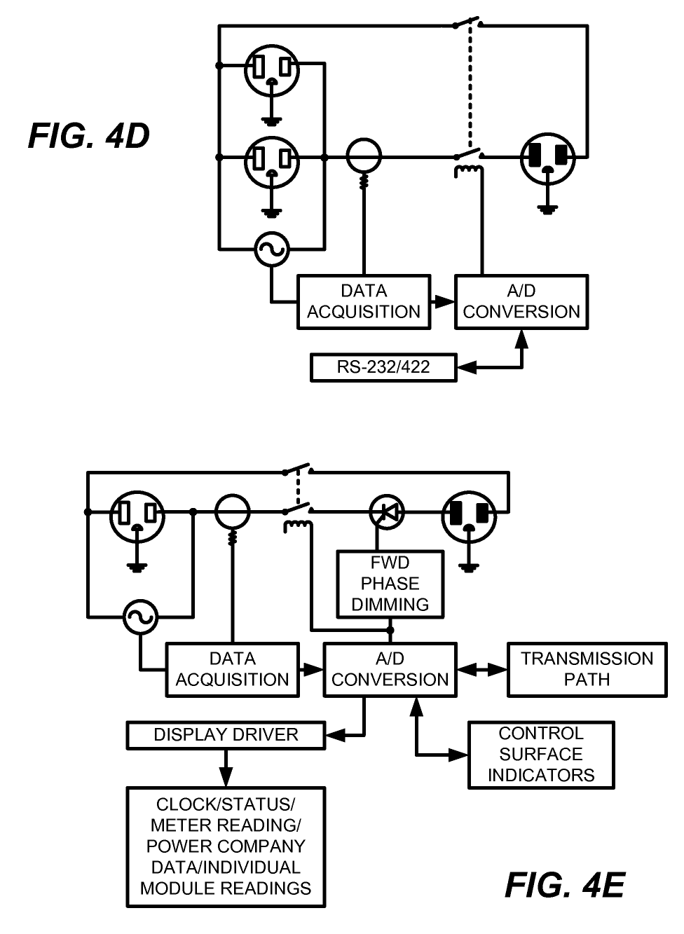

FIGS. 4A-4E depict block diagrams of various embodiments of NIDs. FIG. 4A illustrates an embodiment of a NID for measuring current draw and voltage applied. FIGS. 4B-4E show embodiments of NIDs that also include means for controlling the application of power to a device, such as a controllable switch (e.g., a relay or the like) that may selectively isolate the device 20 from the energy supply, and/or a dimmer. By way of example and not limitation, the energy supply in FIGS. 4A-4E is illustrated as an electrical service, but other forms of resource consumption (e.g., water, gas, etc.) are contemplated. As can be appreciated, the measurement and control of such other resources will entail means suited for the resource. For example, in the case of water, a flow meter and a solenoid controlled valve would be used for measurement and control purposes.

### Exemplary Applications and Configurations

As discussed above, a NID 10 that is capable of controlling the application of power to a device 20 can do so in accordance with commands from hub 12. In an illustrative load-shedding routine, a user may set a configurable threshold (e.g. 100 kW) of total consumption for a residential system and may specify an action to be taken (e.g., remove power from a hot tub heating device) if the threshold is exceeded. Based on consumption information collected from the NIDs in the system, hub 12 will determine the total consumption and compare that to the pre-set threshold. If total consumption exceeds the threshold, hub 200 will then command the NID associated with the hot tub heater to turn off power to the hot tub heater.

The consumer may base an automatic load-shedding routine exclusively on data available to the hub 12. In some embodiments, the consumer may also base the load-shedding routines on information obtained from the utility via the utility meter 16 or the Internet 18.

Also, the consumer may base the decision to shut down a service or device 20 via an NID 10 if the threshold is exceeded and the utility, through the utility meter 16 or the Internet 18, informs the hub 12 that the conditions are “peak” for energy transmission. Further, the consumer may permit a third party (e.g., a utility) to take the control action through the utility meter 16 or the Internet 18 via the hub 12 to shut down a device 20 if certain conditions designated by the consumer are met. The consumer may permit the transfer of information from the hub 12 to a third party via the utility meter 16 or the Internet 18. If the consumer so desires, the control aspect of the hub 12 and the NID 10 may be used as a remote control over the devices 20 connected to the NIDs 10 and turn such devices 20 off at the consumer's discretion.

A consumer may, via UI 14 or a personal computer, for example, access the hub 12 and perform analysis of the consumer's energy system. By way of example and not limitation, the consumer may command the processor of the hub 12 to report analysis such as peak load analysis, indication of peak loads and times of those loads, identification of devices 20 and total consumption of those devices, suggested peak load shedding, and to view pre-configured load control. Also, for other energy such as natural gas, the BTU content per the time of consumption and the amount consumed may be determined and displayed.

In addition, the consumer may configure the hub 12 to generate a communication to the consumer that a consumer configured energy alarm condition has occurred. For example, the hub 12 may be configured to send an email through the Internet 18 or may activate a light or sound on the UI 14 when an alarm condition occurs, such as the energy consumption threshold has been exceeded. The consumer may also command the hub 12 to act via a remote control to the hub.

Also a consumer may evaluate the published efficiency of a new appliance device 20 that is connected to an NID 10. The consumer may, as discussed above, access the hub 12 and determine what the energy consumption is of a specific device 20 and compare that to a published efficiency that is either input by the consumer to the hub 12 or accessed by the hub 12 via the Internet 18, for example. The user may access a database on the hub 12 for efficiency data, such as by entering the manufacturer and the model number of the device 20.

By way of example and not limitation, a power line communications protocol, such as “X10”, can be used to send digitized measurement values from one or more NIDs 10 over existing AC power lines within a building to hub 12 (or central computer) that keeps track of the power consumption over time of each device 20. A NID 10 could be included in a power conditioning unit that is connected via a wired or wireless network to a central server, laptop, or other PC for real time information regarding the power usage of an entire rack or server system that is connected to the power conditioning unit.

Some exemplary, but non-limiting specifications for an exemplary system are: a) hub 12 includes a USB port; b) 8-bit measurement resolution; c) current measurement range of 0.1 amp to 25.5 amps with 0.1 amp increments; c) nonvolatile flash memory with 20 day storage capacity; d) measurement updates every 1 second; e) averaging of measurement data over 5 second windows; and f) RS-232 port for third party controls.

Once measurement data has been acquired by NID 10 or hub 12, there is virtually no limit to what can be done with the data. By way of example and not limitation: a) exchange data with a “smart meter” 16 and with the “smart grid,” including reporting power conditions which are valuable to the utility about the quality of power they are providing and giving the consumer feedback about usage so that they can make informed decisions about when to consume; b) communicate with the user interface 14 which provides various forms of visible feedback to the consumer about the power usage in real- or near real-time; c) communicate with 3rd party products using open source communication protocols (as listed previously for example) to display real time data in more sophisticated projects including automated smart houses and corporate institutions.

The flexibility of exemplary configurations and the programmability of NIDs 10 and hub 12, allows communication with a large number of devices, using established technologies and future technologies that may appear. In further exemplary embodiments, at least some of the above-described capabilities can be embedded in many different types of devices that run on electricity or other energy sources.

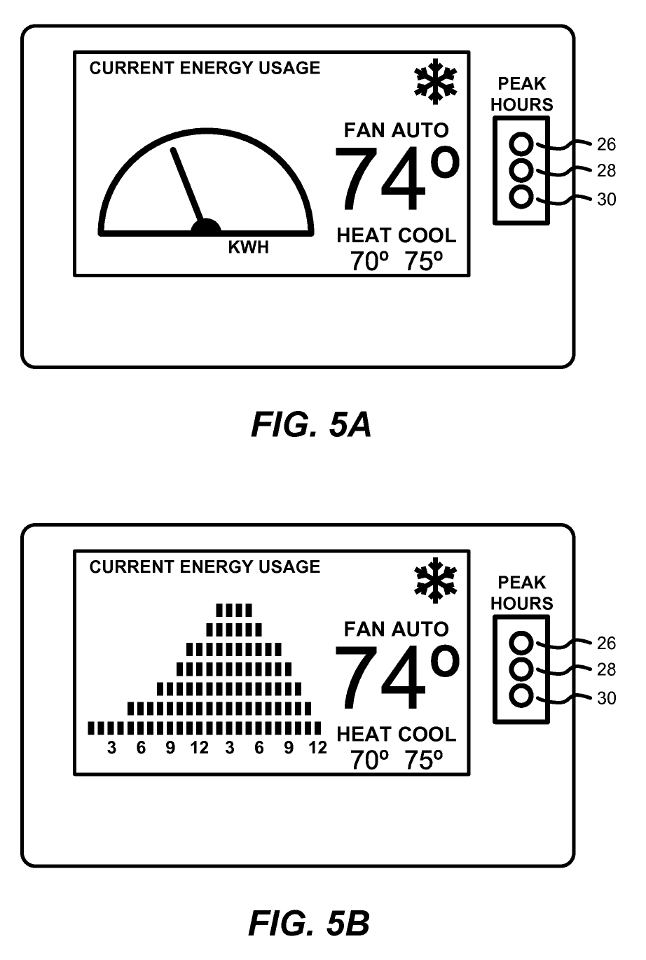

FIG. 5A depicts an exemplary embodiment of UI 14 with a “fuel gage” type of display with a scale that indicates to the consumer what energy is currently being consumed by the consumer's entire system (residence, commercial building or factory, for example). The UI 14 in FIG. 5A also illustrates indicators 26, 28 and 30 that inform a consumer that the system is at respectively, peak energy consumption time, near peak energy consumption time, or not on or near peak energy consumption time. The embodiments contemplate that indicators 26, 28 and 30 may be visual, color coded, have different shapes or may include an audible component.

FIG. 5B depicts an exemplary embodiment of UI 14 with a different image displayed than that of FIG. 5A. In FIG. 5B, the consumer is presented with a bar-type chart that indicates the total energy consumption of the consumer's system per the general time of day the energy was consumed. Many similar types of displays with similar analysis are contemplated.

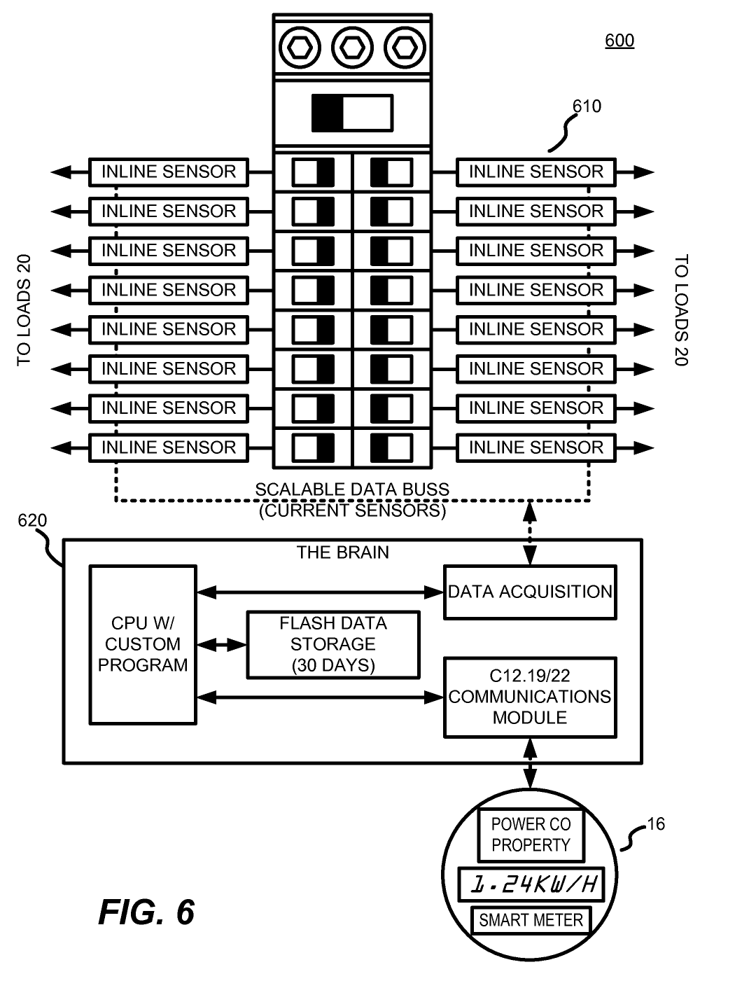

FIG. 6 depicts an exemplary embodiment of a system 600 for use in an electrical power panel configuration for monitoring and/or managing multiple circuits. The system 600 can be configured to perform active load calculations for data collection and real-time demand response support for smart grid applications. The system 600 is capable, preferably, of simultaneous or substantially simultaneous measurement and reporting, remotely (to e.g., utility) and/or locally (e.g., user interface).

In an exemplary embodiment, multiple inline sensors 610 can be bussed. Block 620 may be implemented as a NID or a combination of NID and hub, as described above. Alternatively, each of the sensors 610 may be replaced with a NID, and block 620 implemented as a hub. Each NID can independently turn power on or off to its respective device. This can be done remotely, if desired.

In exemplary system 600, preferably, multiple, simultaneous or substantially simultaneous current and voltage measurements are taken over each cycle, thereby allowing calculation of true rmsVA. In an exemplary embodiment, a sampling period of 0.4 ms to 8 ms is used.

In an exemplary embodiment of system 600, one A/D converter is used to digitize samples from multiple sensors (e.g., 16). A multiplexer selectively switches the sensor outputs to the input of the A/D converter. The multiplexer can be under processor control or can continuously rotate through the inputs in a fixed sequence.

Impedance detection circuitry at the inputs of the multiplexer can be used to automatically detect whether a sensor is coupled to each input. A high impedance condition at an input of the multiplexer would indicate that there is no sensor coupled thereto, in which case any readings from that input can be ignored or the multiplexer can be controlled to skip over that input.

The system 600 can communicate back end lower level, to the power utility or the like, via the End User Defined Table (EUDT) of the C12.19.2008 and C12.22.2008 standards. The back end low level communication is preferably carried out on the application layer through a meter communication protocol instead of being stacked and burdening the meter above it.

Block 620 may have optional RS232, USB and/or LAN interface(s).

While the various embodiments have been described in connection with the preferred embodiments of the various figures, it is to be understood that other similar embodiments may be used or modifications and additions may be made to the described embodiment for performing the same function of the various embodiments without deviating there from. Therefore, the embodiments should not be limited to any single embodiment, but rather should be construed in breadth and scope in accordance with the appended claims.

What is claimed is:

1. A system for monitoring energy consumption, comprising:
a first microprocessor configured to:
receive a measurement of an energy consumption of a predetermined energy load; and
convert the measurement into an electrical signal,
a second microprocessor configured to:
convert the electrical signal into a signal based on a predetermined communication protocol; and
transmit the converted signal based on the predetermined communication protocol to a third microprocessor.

2. A method of monitoring energy consumption, comprising:
measuring an energy consumption of a predetermined energy load;
converting the measured energy consumption into a an electrical signal;
converting the electrical signal into a signal based on a predetermined communication protocol; and
transmitting the converted signal based on the predetermined communication protocol.

3. An energy monitoring and management method comprising:
monitoring at least one parameter relating to an electrical energy consumption of one or more devices;
controlling the provision of electrical energy to the one or more devices;
displaying an indication relating to the electrical energy consumption of the one or more devices; and
communicating data relating to the electrical energy consumption of the one or more devices to a remote location.

4. The method of claim 3, wherein the at least one parameter includes a current drawn by the one or more devices.

5. The method of claim 3, wherein the at least one parameter includes a voltage applied to the one or more devices.

6. The method of claim 3 comprising:
receiving an energy control command, wherein the step of controlling is performed in accordance with the energy control command.

7. The method of claim 3, wherein the step of communicating is performed in accordance with an industry standard.

8. The method of claim 3 comprising:
determining a power parameter based on the at least one parameter monitored.

9. The method of claim 3, wherein the at least one parameter varies periodically and the monitoring step includes sampling the at least one parameter multiple times during a period.
